(19) United States
(12) Patent Application Publication
(10) Pub. No.: US 2004/0054913 A1
(43) Pub. Date: Mar. 18, 2004

(54) System and method for attaching un-forgeable biometric data to digital identity tokens and certificates, and validating the attached biometric data while validating digital identity tokens and certificates

(76) Inventor: Mark Brian West, Dallas, TX (US)

Correspondence Address: MARK WEST, 42910 SE 149TH ST., NORTH BEND, WA, 98045, US

(21) Appl. No.: 09/683,907

(22) Filed: Feb. 28, 2002

(51) Int. Cl. H04L 9/00

(52) U.S. Cl. 713/186; 713/175; 713/156

(57) ABSTRACT

Digital signatures are at best only as good as the digital certificates that are used to create them, and digital identity tokens that are based on digital certificates are at best only as good as the digital certificates therein. Digital certificates are at best only as good as the level of certainty to which the certificate can be associated with the holder. It follows then that digital signatures and digital ID tokens are at best only as good as the level of certainty to which the certificate involved can be associated with the holder. Presented here are: a system for issuing digital certificates wherein biometric data of the certificate requester is irrefutably bound to the issued certificate, and a system for validating the bound biometric data while any validation operation which involves the issued certificate is performed.

### BACKGROUND OF INVENTION

1. Field of Invention

This invention relates to the processes of issuing and validating digital certificates. More particularly, through the use of bound biometric data, the invention adds diligence and integrity to the process of issuing digital certificates and the process of validating digital certificates.

2. Description of Terminology and Background Art

“Public key cryptography (PKC)” is a two key encryption and decryption process. The two keys together are referred to as an asymmetric key pair. With an asymmetric key system, each user has two keys: a public key and a private key. When one key is used for encryption, the other is used for decryption. With this technique, one key can be made publicly available, while the other key is kept secret with its owner or user. The keys are reflexive; that is: a) A message encrypted using a public key can be decrypted only by the owner/user of the matching private key, and b) conversely, a message encrypted with a private key can only be decrypted with the matching public key. Example PKC algorithms, which comply with applicable government or commercial standards, are the digital signature algorithm (DSA/RSA) and secure hash algorithm (SHA-1/MD5).

Various aspects of public-key cryptographic (PKC) systems are described in the literature, including R. L. Rivest et al., “A Method for Obtaining Digital Signatures and Public-Key Cryptosystems,” Communications of the ACM vol. 21, pp. 120-126 (February 1978); M. E. Hellman, “The Mathematics of Public-Key Cryptography”, Scientific American, vol. 234, no. 8, pp. 146-152, 154-157 (August 1979); and W. Diffie, “The First Ten Years of Public-Key Cryptography”, Proceedings of the IEEE, vol. 76, pp. 560-577 (May 1988), “Communication Theory of Secrecy Systems”, Bell Sys. Tech. J. vol. 28, pp. 656-715 (October 1949).

Refer to FIG. 5 for a block diagram illustrating the process of using PKI to transmit an encrypted document over a public medium. In order to send an encrypted document to someone, you need a copy of their public key. You use their public key to encrypt the document, and they use their private key to decrypt the document.

Refer to FIG. 6 for a block diagram illustrating the process of using PKI to digitally sign digital data. When a signer (a user) encrypts a document using a private key, and sends this encrypted document to other recipients (other users) who have access to the user's public key, these users can decrypt the document using the public key to access the original document. In a simple system, this can be visualized as a signer that has signed the document with his/her private key. The recipients can prove the identity of the signer because only the signer has the private key that matches the public key that recipients use for decryption. Practical PKI implementation is based on the fact that all signers sign documents using their private keys, while other users can verify the identity of the signers by using the signers' public keys.

Refer to FIG. 7 for a block diagram illustrating the process of obtaining a digital certificate. Public and private keys are just numbers. To make digital certificates legally binding, there needs to be a mechanism in place to associate a public key to its owner (the user). A Certificate Authority (CA) performs this task. The user generates the two keys, and sends the public key and some personal information to a CA. The CA wraps up the information in a file, and then signs the file, thus creating a digital certificate. When verifying a digital signature, a user looks at the signer's certificate and makes sure that the signature from the issuing CA is valid. To make legally binding signatures, a CA must go to great lengths to authenticate the certificate holder's identity. If an appropriate level of diligence is applied while issuing the certificate, such a certificate may reliably identify the owner of the public key pair, which is used to provide authentication, authorization, encryption, and non-repudiation services.

As illustrated in FIGS. 3a and 3b, a typical digital certificate has the following form: [Version, Serial No., Issuer Algorithm (Hash & Digital Signature), Issuer Distinguished Name (DN), Validity Period, Subject DN, Subject Public Key Info, Issuer Unique Identifier (optional), Subject Unique Identifier (optional), Issuer Public Key, Extensions (optional)]Issuer Digital Signature. A unique DN is formed by concatenating naming specific information (e.g., country, locality, organization, organization unit, e-mail address, common name).

Certificate extensions can be used as a way of associating additional attributes with users or public keys, and for managing the public key infrastructure certificate hierarchy. Guidance for using extensions is available in the recommendations of ITU X.509v3 (1993).vertline. ISO/IEC 9594-8:1995, “The Directory: Authentication Framework” or in IETF Internet X.509 Public Key Infrastructure Certificate and CRL Profile <draft-ietf-pkix-ipki-part1-11>.

A user's digital certificate is often appended to an electronic document with the user's digital signature to facilitate the verification of the digital signature. Alternatively, the certificate may be retrieved from the issuing CA or directory archive.

The “Public Key Infrastructure (PKI)” is the hierarchy of CAs responsible for issuing digital certificates. Certificates and certification frameworks are described in C. R. Merrill, “Cryptography for Commerce—Beyond Clipper”, The Data Law Report, vol. 2, no. 2, pp. 1, 4-11 (September 1994) and in the X.509 specification.

A “wrapper” is a digital structure that is used to contain digital data and optionally associated digital signatures in a standardized form. Examples of such standards are RSA PKCS #7, the W3C XML Signature Syntax and Processing Draft Recommendation, S/MIME, PKIX, XHTML, and XFDL.

A “signature block” usually contains three components: signature data, certificate data, and metadata. Signature data contains the hash of the content encrypted with the private key of the signer, thus creating a digital signature. Certificate data contains the signer's digital certificate. The metadata contains details about the algorithms and methods used to create and define the signature and certificate.

3. Description of the Problem[0001] Statistics show that more than one thousand cases of identity theft are reported in the United States alone each day. The single biggest enabling factor for fraud on the Internet is the anonymity inherent in many of the processes that occur there. Despite many attempts to resolve the situation, it remains trivial for anyone to impersonate another actual or fictitious person.

The best solution available for positive identification on the Internet is the service provided by certificate authorities. Digital certificate technology has been around for several years and is the means by which secure (SSL) transactions can be carried out on web sites. Certificate authorities issue digital certificates to both individuals and to web sites. Web sites with digital certificates are very common, less common is the use of digital certificates by people.

Although most people are not aware, many key products that they use already support digital certificates: MS Internet Explorer™, MS Outlook™, MS Outlook Express™, MS Windows Messenger™, Navigator™, and Lotus Notes™ are just a few examples. These products use digital certificates for identification, signing, and encryption. If you have a digital certificate, you may use it with one of these products to: identify yourself and others, sign documents and e-mails, and share encrypted data with colleagues.

A digital certificate is only as good as the diligence that was used to issue the certificate, and that is major limitation, because with very few exceptions, digital certificates are handed out to anyone with an e-mail address in any name he/she asks for. Some certificate authorities go an extra step and require the certificate applicant to answer some questions that appear on their credit report. This is not a viable solution due to the tremendous amount of identity theft and fraud that occurs in the credit bureau industry.

### SUMMARY OF INVENTION

Presented here is a system and method that tie a person's true identity to that person's on-line activities.

The system and method are equally suited to the task of issuing un-forgeable digital ID cards on a smart card, much like an ATM card but with much more security. The system and method irrefutably bind a card holder's biometric data (photograph, fingerprints, voice print, etc.) to a digital certificate inside a smart card. This is a completely new twist on existing technology, and is easy to implement on existing computers and kiosks. A large benefit of this technology is that it provides absolutely positive identification in real time, without the need for a connection to a central database.

The system and method facilitate positive identification in the physical world as well as on the Internet.

### BRIEF DESCRIPTION OF DRAWINGS

FIG. 1a is a highly abstracted block diagram of the data and processes involved in the standard certificate issuance process performed at a certificate authority.

FIG. 1b is a highly abstracted block diagram of the data and processes involved in the modified (biometric data bound) certificate issuance process performed at a certificate authority.

FIG. 2a is a highly abstracted block diagram of the data and processes involved in validating the authenticity of a digital certificate.

FIG. 2b is a highly abstracted block diagram of the data and processes involved in validating the authenticity of a digital certificate; while simultaneously comparing the level of similarity between the biometric data derived from the certificate and biometric data supplied in from some other source.

FIG. 3a is an abstracted block diagram of the data that comprises a standard X.509 certificate as defined by “CCITT, Recommendation X.509”.

FIG. 3b is an abstracted block diagram of the data that comprises a standard X.509 certificate with the addition of embedded biometric data; while maintaining full compliance with “CCITT, Recommendation X.509”.

FIG. 4a is an abstracted block diagram of the data that comprises a biometric data block with embedded biometric data.

FIG. 4b is an abstracted block diagram of the data that comprises a biometric data block with referenced biometric data.

FIG. 5a is an abstracted block diagram of the process of using PKC to encrypt data.

FIG. 5b is an abstracted block diagram of the process of using PKC to decrypt data.

FIG. 6a is an abstracted block diagram of the process of using PKC to digitally sign data.

FIG. 6b is an abstracted block diagram of the process of using PKC to verify a digital signature.

FIG. 7 is an abstracted block diagram of the process of using PKC and PKI to request, issue, and acquire a digital certificate.

### DETAILED DESCRIPTION

The inventions can be implemented utilizing commercially available computer systems and technology to create and verify digital certificates with embedded biometric data.

1. Certificate Issuance.

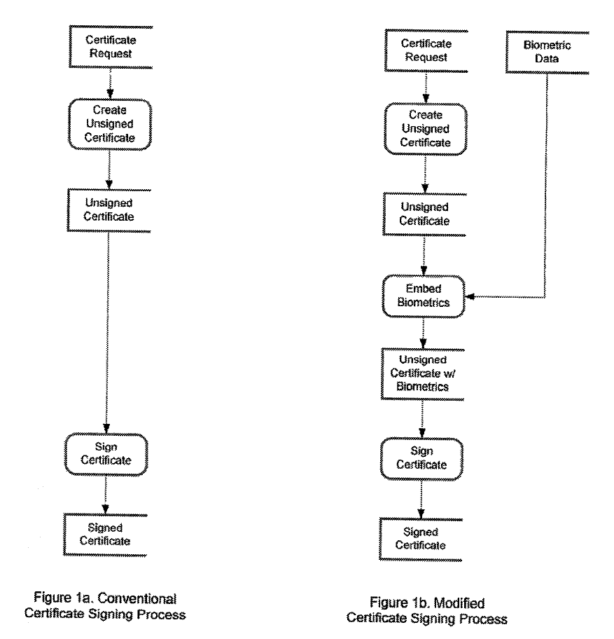

FIG. 1b is a block diagram of the data and process involved in the portion of the invention which embeds the biometrics into a digital certificate.

In this process some form of biometric data is submitted to a certificate authority (CA) in such a manner as to positively associate the data with a digital certificate request. The methods for submitting the biometric data are not in the scope of the invention.

Through currently established cryptographic procedures the CA extracts certain key fields of data from the certificate request and places these fields of data into an unsigned digital certificate.

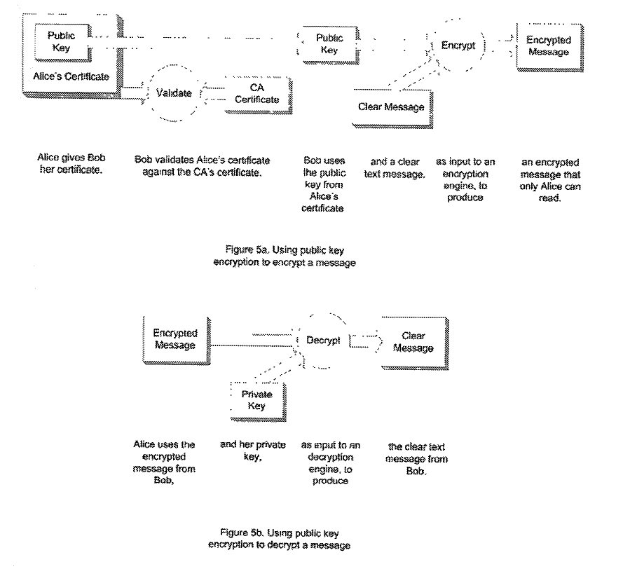

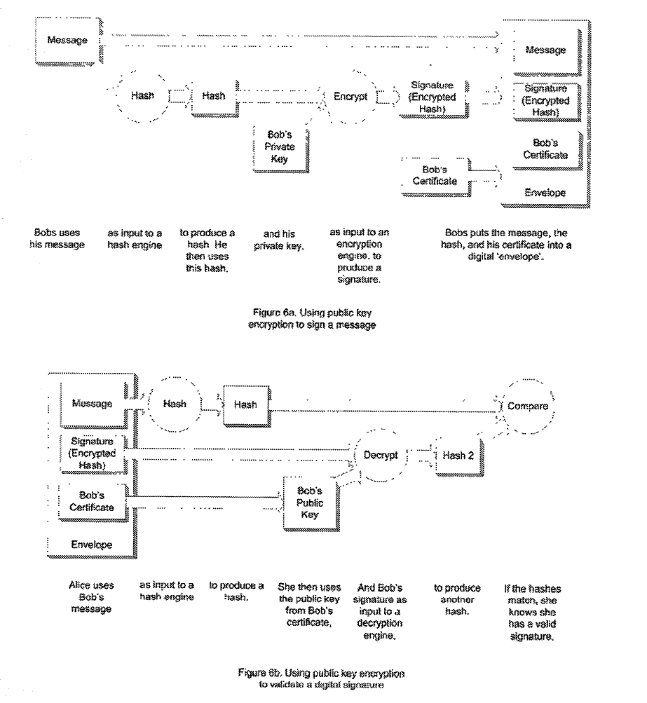

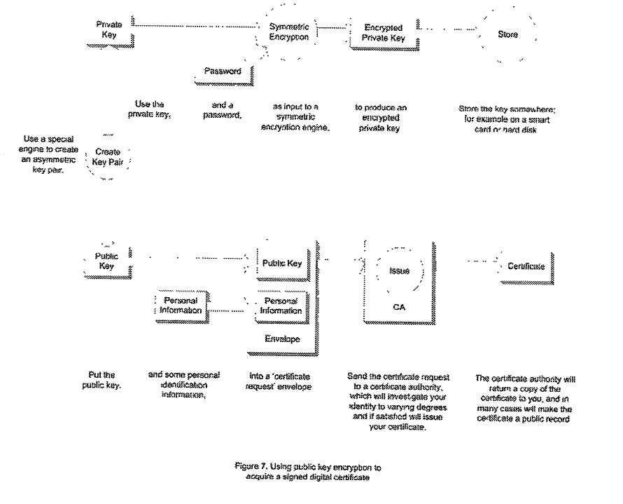

A “Biometric Data Block” data structure of a specific format is created. FIGS. 4a and 4b depict possible formats for the data structure.

FIG. 4a depicts a biometric data block into which the biometric data is placed, along with a digital signature of the biometric data and various fields of data which define parameters of the biometric data and signature.

FIG. 4b depicts a biometric data block into which a reference to the location of biometric data is placed, along with a digital signature of the biometric data and various fields of data which define parameters of the biometric data and signature. The location of the biometric data may be specified in any manner of ways, including but not limited to a URL, a URN, or an XPath.

The biometric data block created in [0040] is embedded into the certificate extension portion of the unsigned digital certificate created in [0039].

The unsigned certificate is then signed by the CA in accordance with currently established cryptographic procedures, yielding a signed digital certificate.

The signed digital certificate is then conveyed to the original certificate requester through some means which are not in the scope of the invention.

2. Certificate Validation.

Many distinct processes such as signing and identification on the Internet and in the real world ultimately depend on the validation of a digital certificate.

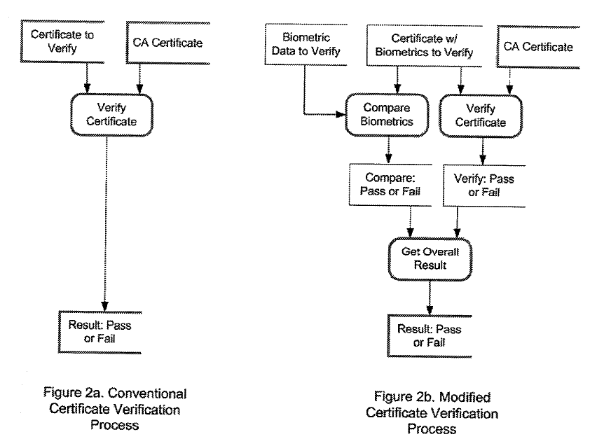

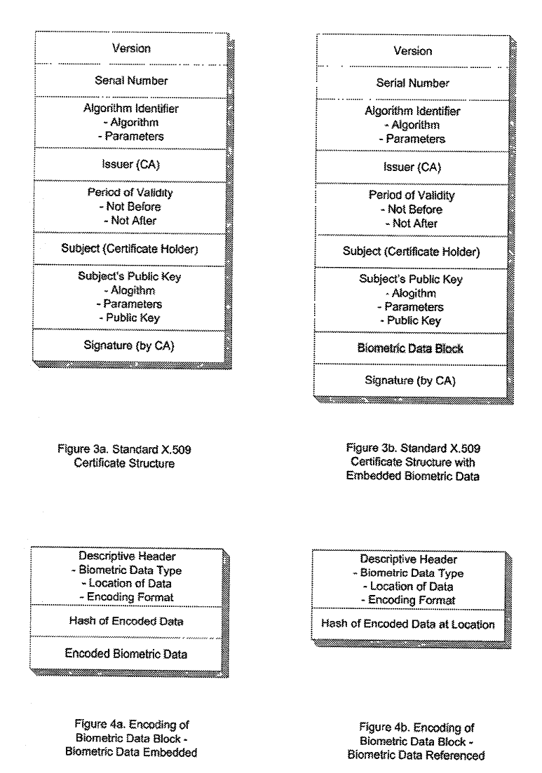

A block diagram of the established process of validating a digital certificate is presented in FIG. 2a. In this process the certificate to be verified as well as the certificate of the signing CA are input into a “Verify Certificate” module which determines whether or not the certificate to be verified contains a valid signature applied by the CA. The module in effect produces a “Pass or Fail” result.

FIG. 2b represents a block diagram of the process of validating a digital signature and validating the biometric data bound to the certificate.

In this process the certificate itself is validated using the conventional process presented in FIG. 2a. In addition a parallel process of “Pass or Fail” validation of the bound biometric data is performed. If both of the validation processes pass, the certificate and biometric data to verify are deemed valid. If either process fails, the certificate shall be deemed invalid.

Referring to FIG. 2b; the “Compare Biometrics” module takes two objects as input: 1) biometric data to verify, and 2) biometric data bound to the certificate.

Referring to FIG. 2b; the “Compare Biometrics” module compares biometric data in a manner which applies to the particular type of biometric data being compared. For example; fingerprint data may be compared using a algorithm which depends on statistical closeness of minutia sets, or a photograph may be compared to a live human with the help of a human authority standing at a security checkpoint.

Referring to FIG. 2b; the origin of the “Biometric Data to Verify” is not defined in the scope of the invention, but for illustrative purposes several representative origins and applications are presented below.

Sample 1; a guard at an airport checkpoint manually verifies that the photograph derived from a certificate in a digital ID card matches the appearance of the person presenting the ID card.

Sample 2; an ATM machine collects a fingerprint from a customer via a fingerprint reader device, and then uses a statistical minutia matching algorithm to determine if the fingerprint collected in real time matches the fingerprint derived from the certificate in the presented ATM card.

Sample 3; an on-line access control device requires that the user present a smart card as well as speak a phrase into a microphone. The control device performs a comparison between the voiceprint derived from the smart card with the live voice print collected over the microphone.

It will be noted that this description and the drawings are illustrative only and that one of ordinary skill in the art would recognize that various modifications can be made without departing from the essence of these inventions, which is defined by the following claims.

1 A method of securely binding a digital representation of biometric data to a digital certificate in such a manner as to facilitate the positive identification of the party to whom the digital certificate was issued:

2 A Method of validating the authenticity of certificate bound biometric data at the time of performing other certificate validation processes.

3 The method of claim 1, wherein a digital certificate is issued to a person, entity, or device.

4 The method of claim 1, wherein biometric data of the requester is submitted to the certificate authority in such a manner as to positively associate the biometric data with a matching certificate request.

5 The method of claim 4, wherein the biometric data submitted may be any form or combination of digital data which represents a biological characteristic or combination of biological characteristics of such capacity as to uniquely identify a physical person. Such data may contain but is not limited to such elements as: a photograph, a set of fingerprints, a voice pattern, a retinal scan, or a DNA sequence. Such data specifically does not contain such generic elements as hair color, eye color, body weight, race, gender, name, and address.

6 The method of claim 1, wherein the biometric data submitted in claim 4 is embedded into a certificate prior to the signing of the certificate by a certificate authority.

7 The method of claim 6, wherein the certificate created and signed by the CA is a digital certificate as defined by any standard.

8 The method of claim 6, wherein the certificate created and signed by the CA contains biometric data that may be extracted and validated by applications specifically designed to do so.

9 The method of claim 6, wherein the biometric data embedded into the certificate created and signed by the CA does not cause the format of the certificate to deviate from the standard by which the certificate was defined, and does not render the certificate in any way invalid or unusable by any application which may use the certificate as input and which fully supports the standard by which the certificate was defined.
